(19) United States
(12) Patent Application Publication
(10) Pub. No.: US 2003/0069741 A1
(43) Pub. Date: Apr. 10, 2003

(54) Method for verifying and limiting personal information use from one location

(76) Inventors: Daniel R. Hoyer, (US); Elmer A. Hoyer, (US)

Correspondence Address: Daniel R. Hoyer, 845 N. Kessler, Wichita, KS, 67203, US

(21) Appl. No.: 09/972,457

(22) Filed: Oct. 5, 2001

(51) Int. Cl. G06F 17/60

(52) U.S. Cl. 705/1

(57) ABSTRACT

The present invention will centrally collect all required data to allow numerous Internet websites to comply with the Children's Online Privacy Protection Act of 1998 (COPPA). A method for the giving, editing, and revoking permission for a business Internet website to use information will also be an intricate part of the invention. Individual users of this invention will be required to provide the required proof of age and identity only once. Individual users will be able to then provide participating businesses a method for collecting verification, as well as limiting the personal information the Individual user allows, without the enormous cost that the current methods entail. The key feature of this invention is to centrally locate all the required information and verification needed to comply with COPPA. The problem with the current methods of collecting personal data is that companies have to collect and verify the data independently. The current invention solves this problem by having a centralized location for collecting and verifying individual's personal information. The major benefit to the individual user is the ability to only have to provide the required documents, to comply with COPPA, to one company. It will also allow the individual user more control over who, what, when and where their personal data is accessed and used. The business user will benefit from this invention as well. Business users will no longer be required to collect and verify the individuals pertinent information. The business user will also not be required to build a system to handle the complexity of automating the verification, permission and revocation systems.

### BACKGROUND

1. Field of Invention

This invention relates to information storage and the process by which the information is collected and limiting the distribution of the resulting data.

2. Description of the Prior Art

One of the current methods for the collecting of personal data for the purpose of complying with Children's Online Privacy Protection Act of 1998 (COPPA) is for companies to collect and verify the data independently. This is not only a cumbersome process for the business, but it's a difficult process for the customer to alter the permission or information given.

Furthermore, adults wanting to verify that they are of legal age to access certain areas of a website are often forced to send in paper work to prove that they are in fact of legal age thus delaying the process accessing the website. Another COPPA compliant way to verify age is to collect credit card information. This is not only an ineffective way to verify, but it would require a user to provide their credit card information to numerous business owners when they have no intent of buying anything from the business. There is also no way to verify the owner of the credit card and the individual providing the credit card information on-line is the same person.

All of the current methods require individuals to provide verification information separately to each company for which they want to access the companies website. In addition, the current methods are cost prohibitive for the individual businesses to insure compliance with COPPA.

Advantages

The problem with the current methods of collecting personal data, for the purpose of complying with the COPPA, is that companies have to collect and verify the data independently. The current invention solves this problem by having a centralized location for collecting and verifying individual's personal information. The current invention will also allow the individual to provide permission to individual companies to use the personal information as well as restrict what information is provide to the individual companies. Individual users can also revoke permission altogether. The major benefit to the individual user is the ability to only have to provide the required documents, to comply with COPPA, to one company. It will also allow the individual user more control over who, what, when and where their personal data is accessed and used. The business user will benefit from this invention as well. Business users will no longer be required to collect and verify the individuals pertinent information. The business user will also not be required to build a system to handle the complexity of automating the verification, permission and revocation systems.

### BRIEF SUMMARY OF THE INVENTION

The present invention will centrally collect all required data to allow numerous Internet websites to comply with the Children's Online Privacy Protection Act of 1998 (COPPA). A method for the giving, editing, and revoking permission for a business Internet website to use information will also be an intricate part of the invention. Individual users of this invention will be required to provide the required proof of age and identity only once. Individual users will be able to then provide participating businesses a method for collecting verification, as well as limiting the personal information the Individual user allows, without the enormous cost that the current methods entail. The key feature of this invention is to centrally locate all the required information and verification needed to comply with COPPA.

### BRIEF DESCRIPTION OF THE DRAWING

FIG. 1 is a flow chart describing the process in which a individual user will access the centralized system;

FIG. 2 is a diagram describing the individual verification process of FIG. 1;

FIG. 3 is a diagram describing the individual profile editing process of FIG. 1;

FIG. 4 is a diagram describing the individual business edit process of FIG. 1;

FIG. 5 is a diagram describing the individual, business and database interface process of FIG. 1;

FIG. 6 is a flow chart describing the process in which a business user will access the centralized system;

FIG. 7 is a diagram describing the business sing up process of FIG. 6; and

FIG. 8 is a diagram describing the edit business options, required information and registration information process of FIG. 6.

FIG. 9 is a diagram describing a brief overview of the total process.

### DETAILED DESCRIPTION OF THE INVENTION

The following description, by way of example, is the best method contemplated by the inventors for carrying out the invention. Further more, numerous specific details are set forth in order to provide a thorough understanding of the present invention. It is apparent however, to one skilled in the art, that the present invention may be practiced without limitation to these specific details. In other instances, well known methods and structures have not been described in detail so as not to unnecessarily obscure the present invention.

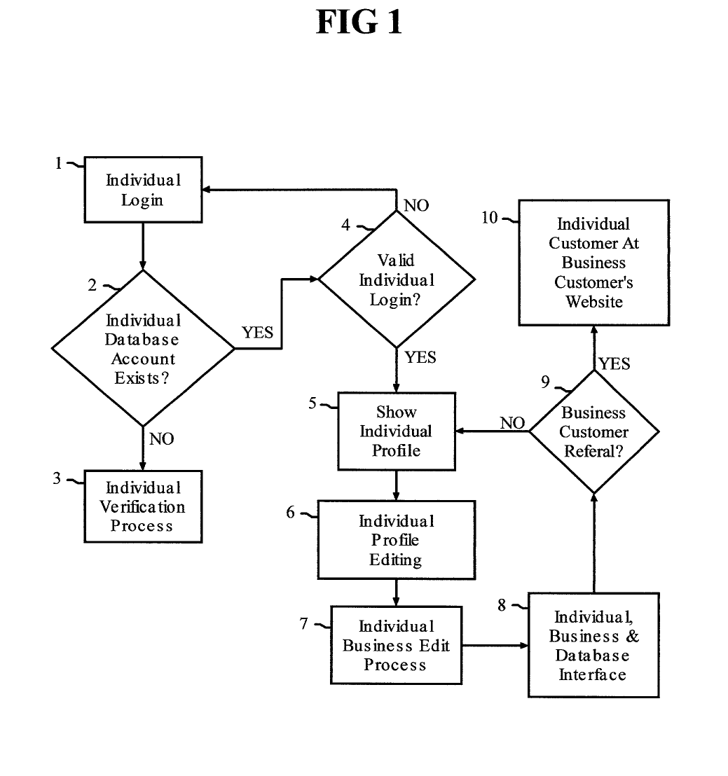

Referring first to FIG. 1, an individual user, using their Internet web browser and an Internet connection, will access the centralized database site 1 by way of a business web site (referred) or directly (not referred). The centralized database interface (hereafter known as database) system will then determine whether or not the individual user has an account 2 based on the user name and password supplied by the individual user. If the user name and password does not exists the user will be prompted to create and account 3. If the account does exists, the database will determine if the login is a valid login 4. If the login was not valid, the user will be directed to login again 1. Once the individual user has logged in successfully, the user will be presented with the account's profile 5. The individual can then select a sub-profile that they want to use to add the business profile to 6. At that point, the individual can opt to add as many sub accounts to their main account 6 as they need. Once the individual has selected a sub-profile, they will then be taken to the individual business edit process 7 where they will provide information that is required and requested by the business user. Once accepted 8, the database will determine whether the user was referred or not referred 9. If referred, the individual will be sent to the business website's web page to complete the business customer's account setup 10. All other individual users will be shown the individual profile again 5.

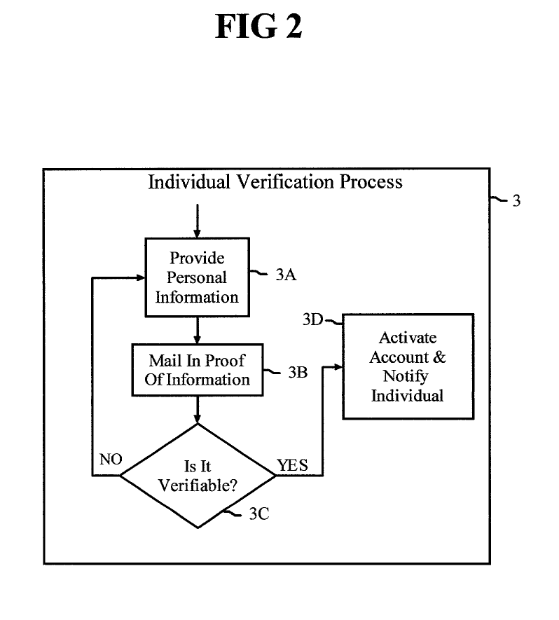

Referring next to FIG. 2, shown is a detailed diagram of the individual verification process 3 (FIG. 1). The individual user will be prompted, via the Internet browser, to provide basic personal information, 3A like their first and last name, address and age, as well as the user name and password they wish to use for future access to the database. Next the individual will be provided with a form (account application), which will be in a format suitable for printing. The individual will then be required to print this form out and mail it 3B and any other proof of identity needed to the designated postal address 3B. Once received, the employee in charge of verifying information and updating the database will look over the application to make sure all verification requirements have been met 3C. If met, the employee will activate the individual's account 3D which will cause the database to automatically notify the user 3D.

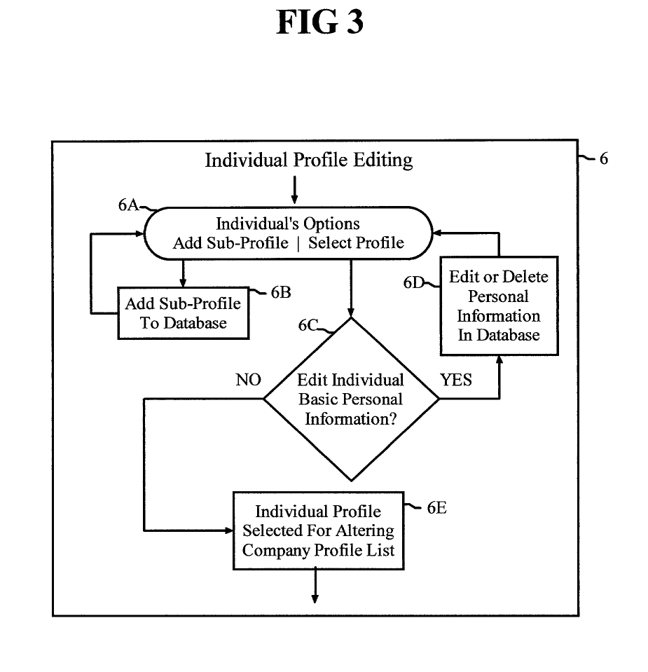

Referring next to FIG. 3, shown is a detailed diagram of the individual profile editing process 6 (FIG. 1). The individual will be presented with two options 6A, adding a sub-profile and selecting a profile or sub-profile. When the adding a sub-profile option is selected, the individual will be prompted with a form requiring the individual to provide basic personal information 6B like their first and last name, address and age. Once accepted, the user will be redirected the individual options selecting process 6A. If the individual user chooses the select profile option 6A, they will be asked if they wish to alter the personal information that was given when the profile was created or last altered 6C. All information in the profile or sub-profiles can be edited with the exception of the main profile's first and last name. This is done to insure that the person that opens the account doesn't change. If that information needs to be changed, the new person will have to apply for an account of their own 3 (FIG. 1). Once the alterations are done, the database will be updated 6D to show the changes. If the individual choose to delete the main profile, the individual's information and all sub-profiles will be deleted from the database and the user will no longer be able to access the system. If no alterations need to be done to the profile, the user will have successfully select a profile to add the company profile too 6E and the user will be forwarded to the next step.

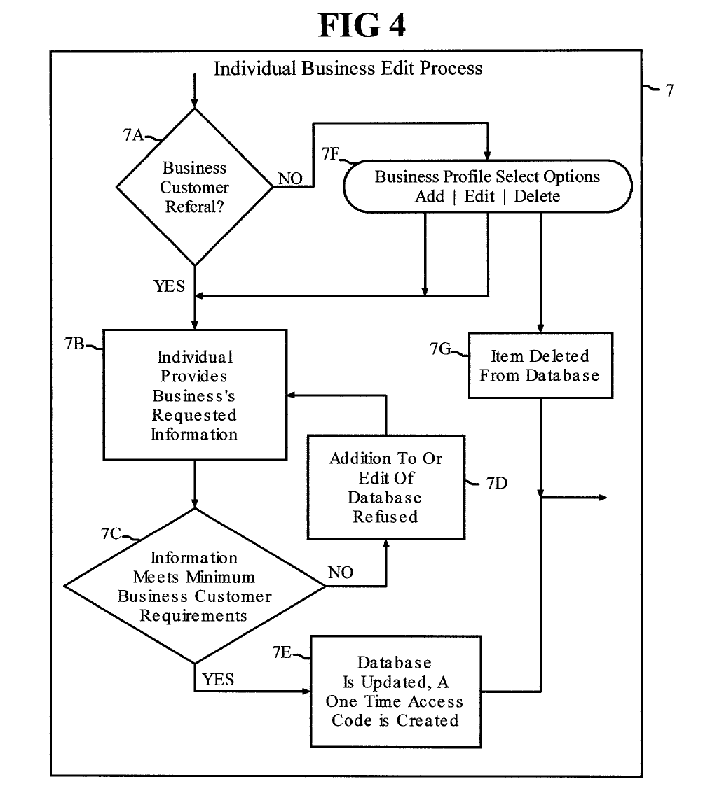

Referring next to FIG. 4, shown is a detailed diagram of the individual business edit process 7 (FIG. 1). The first step is to determine whether the individual user was referred by a business user 7A. If it was a referral, the business user's profile will automatically be selected and the individual will be prompted to provide the business's requested information 7B. If it was not a referral 7A, the individual user will be presented with the option to add, edit or delete the business profile 7F. From these options, both the add and edit options will direct the customer to enter the business user's requested information 7B. If the individual selected edit, the current requested information in the database will have been pre filled out on the internet web form. Once the individual user has filled in the business requested information and submitted it for approval, the database will determine whether it meets the minimum requirements 7C set by the business user's profile. If the information provide by the individual user did not meet the minimum requirements 7D, the application request will be refused and they will be presented with the business requested information form again showing which fields need to be filled in to be acceptable. Once accepted, the database is updated and a one time access code is created. From the business profile select options 7F, if the individual selected to delete the business profile, the item will be deleted from the database 7G and the individual user will no longer be able to access their account on the business user's website.

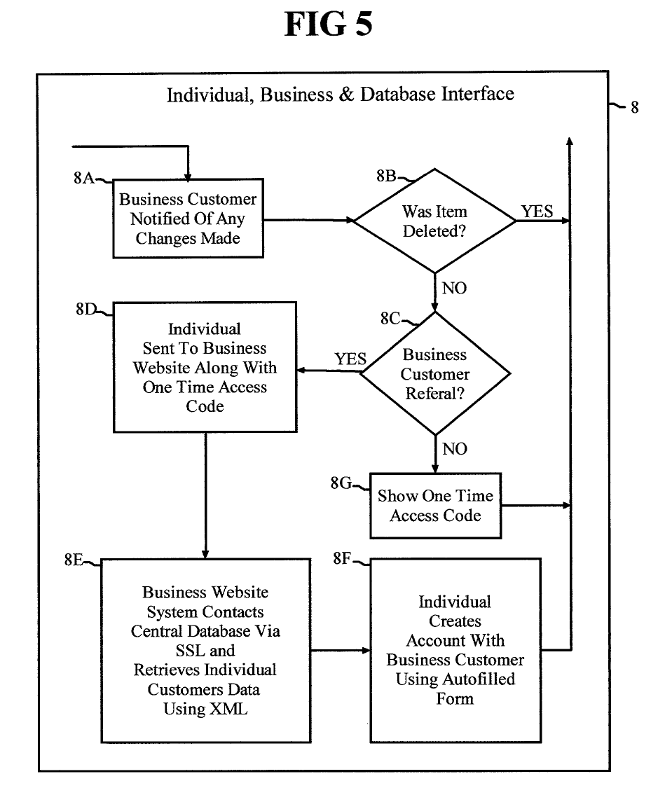

Referring next to FIG. 5, shown is a detailed diagram of the individual, business and database interface process 8 (FIG. 1). First step is to notify the Business customer of any changes 8A so that they can update their records for the individual user accordingly. If the action was to delete 7G (FIG. 4), no other action is needed in this part of the process. If the action was not to delete, the database will detect whether this was a business referral or not 8C. Non referrals are shown the one time access code 8G and are presented with the option of clicking on a hyperlink to visit the business website with the one time access code to complete the business website's account sign up process. Referrals are automatically redirected to the business user's website along with the one time access code 8D. Once at the business user's website, the business website contacts the central database via a secure connection (SSL) so it can retrieve the authorized individual users data via XML 8E. Once the information has been retrieved, the business user's website will automatically fill in the form and allow the individual to create an account with them using this information.

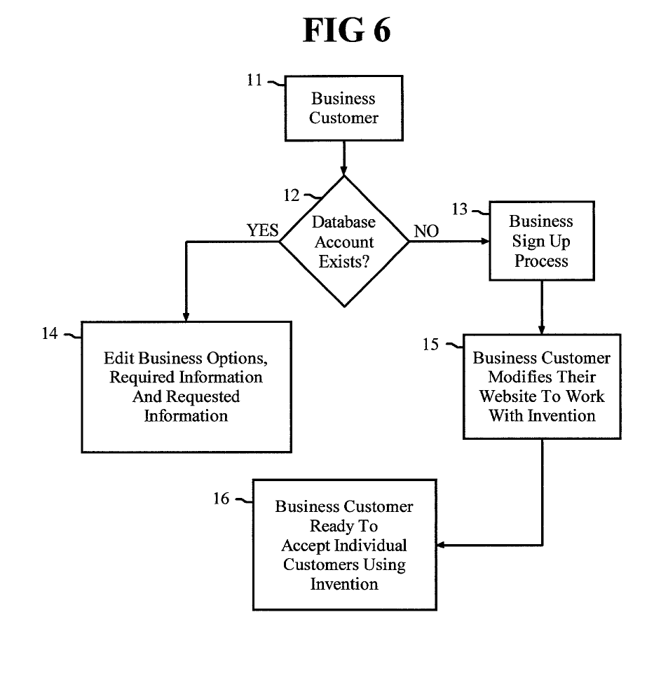

Referring next to FIG. 6, a business user, using their Internet web browser and an Internet connection, will access the centralized database site 11. The first step is to decide whether or not the business user has an account profile in the database 12. If not, the business user is prompted to create one 13. Once the business user has been accepted, they will be directed to alter their website and data collection system to work with the database 15. Once all these steps have been completed, they will be ready to accept individual customers using the database 16. If the business user currently has an account profile in the system, they will be able to view current profile settings and make changes to their profile 14.

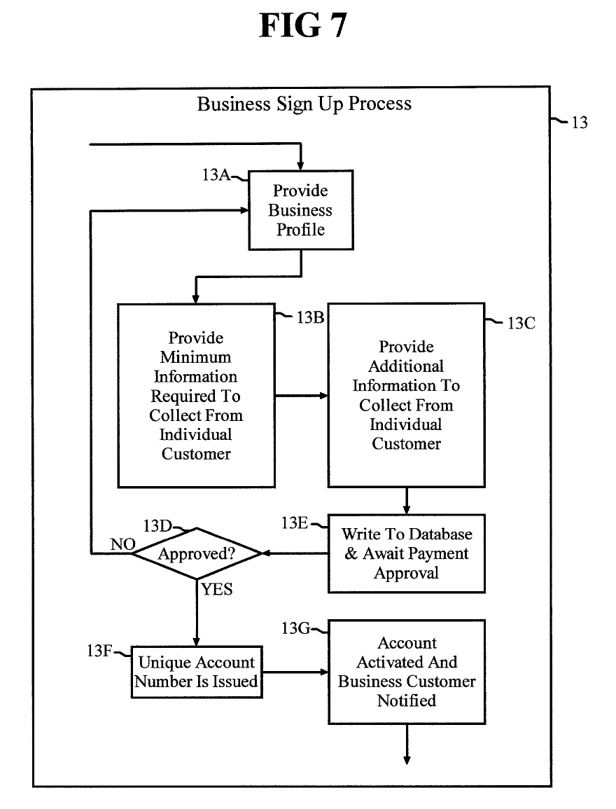

Referring next to FIG. 7, shown is a detailed diagram of the business sign up process 13 (FIG. 6). Business users will be required to provide basic information to make up their profile 13A along with being required to provide a privacy policy that complies with the Children's Online Privacy Protection Act of 1998 (COPPA). The business user will be then prompted to provide the minimum amount of information 13B that they will require before allowing an individual user to create an account with them. After supplying the information to be required from individual users, the business user will be prompted to provide a list of any other information that they wish to collect from individual users 1 3C. Once this has been provided, the information will be written to the database and the database will wait for payment approval 13E. If it was approved 13D, a unique account number is issued to the business user 13F. The business user's account is then activated and notified of the activation 13G. If the account was not approved, the business user will be redirected to start the account sign up process again 13A.

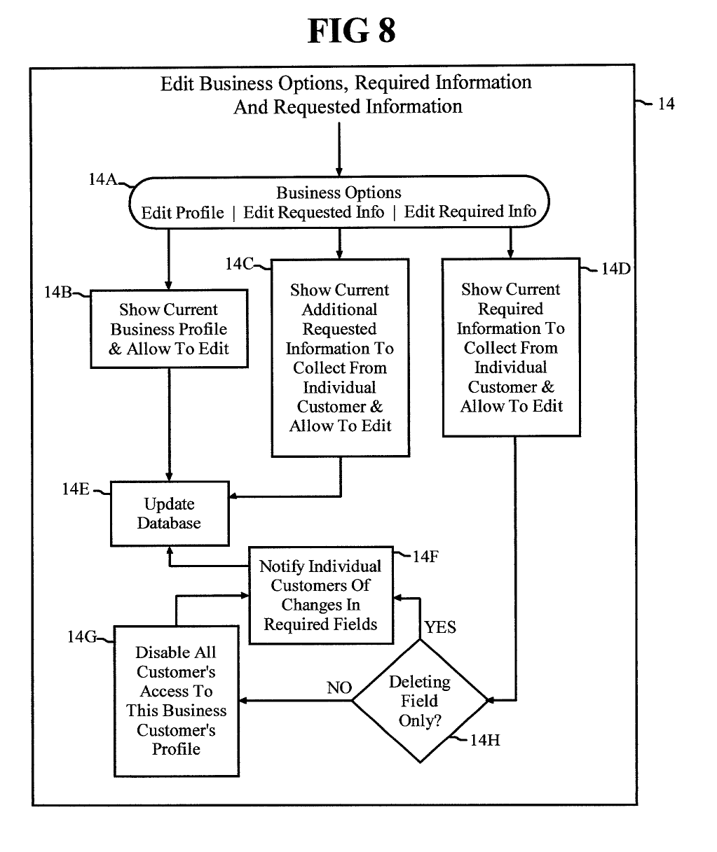

Referring next to FIG. 8, shown is a detailed diagram of the edit business options, required information, and requested information process 14 (FIG. 6). Once the business user arrives at this step of the process, they will be allowed to select from three business profile options 14A. The options are edit profile, edit requested information and edit required information. When the business user selects edit profile 14A, the database will provide them with the current profile and allow them to edit 14B. Once the alterations have been made, the database will be updated as long as all information provided is of a valid format. When the business user selects edit requested information 14A, the database will provide them with the current additional information to collect from individual customers and allow the business user to edit 14C. Once the changes are submitted by the business user, the database will be updated 14E. When the edit required information 14A option is selected, the business user will be provided with the current required information that is in the database and allowed to edit 14D. Once submitted, database will then determine if the business user is only deleting a field(s) 14H. If there are only field(s) being deleted 14H, then only the individual users that have the current business user's profile in their individual user's profile will be notified of the changes 14F. The database will then be updated 14E. If any other changes have been made, then all individual users that have this business user's profile will have their access suspended 14H until they reapprove the business users website for access. They will then be notified of these changes 14G followed by the database will be updated 14E.

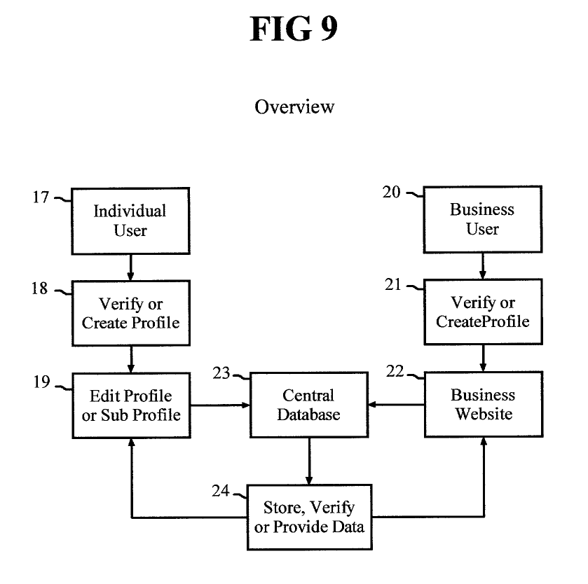

Referring next to FIG. 9, shown is an overview of the total process. 17, 18 and 19 show the process that the individual user will partake. 20, 21 and 22 show the process the individual business will partake. 23 and 24 are the process the centralized database will partake.

The problem with the current methods of collecting personal data, for the purpose of complying with the COPPA, is that companies have to collect and verify the data independently. The current invention solves this problem by having a centralized location for collecting and verifying individual's personal information. The current invention will also allow the individual to provide permission to individual companies to use the personal information as well as restrict what information is provide to the individual companies. Individual users can also revoke permission altogether. The major benefit to the individual user is the ability to only have to provide the required documents, to comply with COPPA, to one company. It will also allow the individual user more control over who, what, when and where their personal data is accessed and used. The business user will benefit from this invention as well. Business users will no longer be required to collect and verify the individuals pertinent information. The business user will also not be required to build a system to handle the complexity of automating the verification, permission and revocation systems.

What is claimed is:

1. A method of collecting and verifying an individuals personal data, comprising:
(a) a means for presenting individual users with the said requested information to be collected,
(b) a means for collecting and temporarily storing said data so it can be used later in the verification process,
(c) a means for providing a method for individual users to physically send in a signed verification form,
(d) a means for receiving said signed verification form from individual,
(e) a means for verifying that said form contains all required information,
(f) a means for storing said verified data in a centralized database.

2. A method of collecting vital individual business data, comprising:
(a) a means for an individual business to provide data that is required to initiate an individual business account,
(b) a means for an individual business to provide data that is required to be collected from the said individual user according to claim 1,
(c) a means for an individual business to provide data that is requested to be collected from the said individual user according to claim 1.
(d) a means for storing said data in a centralized database.

3. A method of storing all said data collected according to claim 1 and claim 2 in a centralized database, comprising:
(a) a means for temporarily storing said unverified individual data,
(b) a means for storing said verified individual data and said business data,
(c) a means for allowing limited access to said individual data in compliance with COPPA.

4. A method for allowing individual users the ability to maintain their said individual data in said database according to claim 3, comprising:
(a) a means for adding and maintaining said individual users sub accounts,
(b) a means for maintaining said individual users main account,
(c) a means for adding, deleting and editing individual business accounts that are allowed to access individual users sub account data,
(d) a means for adding, deleting and editing individual business accounts that are allowed to access individual users main account data,
(e) a means for restricting what individual users sub account data can be accessed,
(f) a means for restricting what individual users main account data can be accessed,
(g) a means for revoking access by an individual business user to an individual users sub account data,
(h) a means for revoking access by an individual business user to an individual users main account data
(i) a means for storing said data in said centralized database.

5. A method for allowing an individual business the ability to maintain said individual business data in said database according to claim 3.

6. A method for individual businesses to access and retrieve data from the said centralized database according to claim 3.
